(19) United States
(12) Patent Application Publication
(10) Pub. No.: US 2025/0103979 A1
(43) Pub. Date: Mar. 27, 2025

(54) SYSTEM AND PROCEDURE FOR EFFICIENT UTILIZATION OF UNDERUTILIZED AGENTS BY USING REVERSE STAFFING

(71) Applicant: NICE LTD., Ra’anana (IL)

(72) Inventors: Saurabh GUPTA, Pune (IN); Sanjeev HEMNANI, Pune (IN); Kushagra DUBEY, Pune (IN)

(21) Appl. No.: 18/476,178

(22) Filed: Sep. 27, 2023

(51) Int. Cl. G06Q 10/0631

(52) U.S. Cl. CPC G06Q 10/063118

(57) ABSTRACT

Agent utilization systems and methods, and non-transitory computer readable media, include receiving net staffing data for an organization; identifying opportunities for agents by: calculating available agents per interval (AAI) information based on the net staffing data, calculating total addressable contacts (TAC) information based on the AAI information, and calculating opportunity information for a calling list opportunity, a coaching opportunity, a re-allocation opportunity, or a combination thereof, based on the TAC information; displaying the calling list opportunity, the coaching opportunity, the re-allocation opportunity, or a combination thereof, alongside the opportunity information; receiving a selection of one of the calling list opportunity, the coaching opportunity, the re-allocation opportunity, or a combination thereof; and in response to the selection, automatically implementing the selected calling list opportunity, the selected coaching opportunity, the selected re-allocation opportunity, or a combination thereof, in a workforce management system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems for identifying and implementing opportunities for agents, and more particularly to methods and systems that identify agent opportunities for both understaffing and overstaffing situations.

### BACKGROUND

In a contact center, there are overstaffing situations that currently result in underutilization of resources and agents. This situation occurs when an organization wants to cover its peak load efficiently. Hence, a group of agents are hired by contact centers to meet this peak load. However, the usual call volumes are not always at the peak load, which can lead to the following situations: (1) underutilization of resources and agents, and/or (2) employees becoming unsatisfied due to lack of utilization of their proficient skills, which results in fewer payouts. At present, call volumes decide the staffing and scheduling requirements for an organization.

The supervisors/managers generally only know net staffing information. They are unaware of opportunities elsewhere in the contact center, which keeps various agents underutilized despite opportunities for increased or better agent utilization.

Accordingly, what is needed is a solution that provides recommendations to managers and supervisors when there is an overstaffing or understaffing condition.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a system according to embodiments of the present disclosure.

FIG. 2 is an exemplary architecture of a reverse opportunity calculator according to embodiments of the present disclosure.

FIG. 3 is a flowchart of a method according to embodiments of the present disclosure.

FIGS. 4A-4F illustrate exemplary user interfaces according to embodiments of the present disclosure.

FIG. 5 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

In today's world, contact volumes often decide the staffing and scheduling requirements for an organization. The present disclosure uses a reverse complementary process that identifies the available staff after the schedules are generated and reverse calculates the amount of work various staff (e.g., agents, supervisors, coaches, other managers, etc.) can handle to identify both understaffing and overstaffing situations. The presently disclosed systems and methods can size, map, and recommend the right opportunities to the supervisor or manager for running other business functions, such as automatic communication distributor (ACD) calling lists, coaching, and staff reallocations using the unutilized capacity that is discovered.

Every workforce management (WFM) system does a reasonable job of exposing differences in staffing, but the present disclosure takes it to the next level in offering recommendations to managers and supervisors and acting right within a workflow that is contained in the existing WFM solution. The volume and staff predictions are unidirectional in conventional WFM systems, i.e., they predict the communications first and then schedule. The presently disclosed systems and methods find inefficient situations in contact centers and work bi-directionally to give actionable items to the supervisors and managers. Advantageously, supervisors and managers receive automatic system recommendations with their corresponding opportunity score as discussed herein, and they can decide if the agents can be used for calling lists, coaching, or reallocated for other schedule changes.

Overstaffing is an expensive problem. Oftentimes, the go-to WFM recommendation for understaffing is to send agents home, but what happens if volumes unexpectedly start to spike in an hour or two? Continuing to have the agents on the clock can help cover the risk of conditions changing again, better eliminate understaffing or overstaffing discrepancies, and it lets the staff focus on more meaningful tasks in the interim.

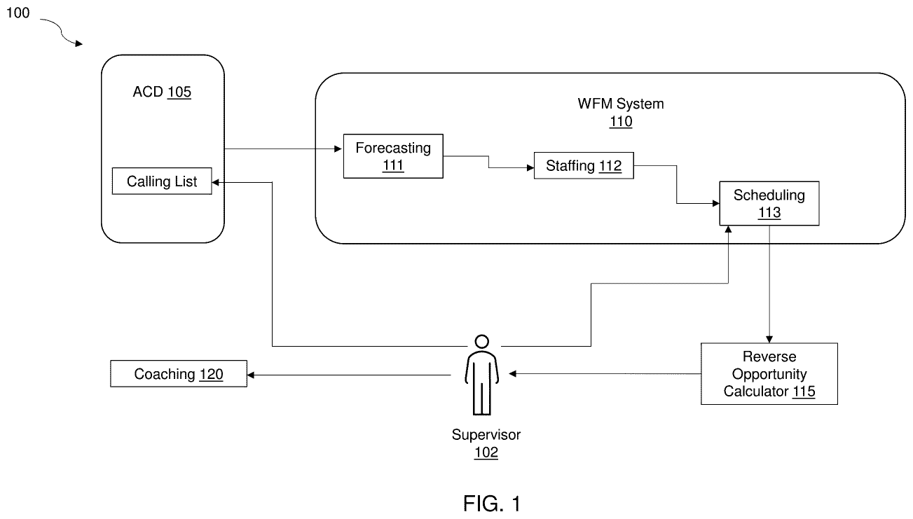

Referring now to FIG. 1, shown is a system 100 according to various aspects of the present disclosure. ACD 105 is a communication or contact routing system that has the capability to route incoming contacts (e.g., calls, chats, SMS, email, digital, social) in a contact center to the right agents who can handle and solve customer queries. In some embodiments, ACD 105 generally connects the agent with the highest proficiency for a given skill or set of skills to a customer. These are typically skills expected to be required in the customer interaction, but alternatively may be overall skills of the agent. Typically, an ACD routes telephone calls, but any type of work item or communication can be given a digital signature and routed via the ACD. ACDs are specialized systems that are configured to match a work item to an available agent. ACDs generally receive incoming work items, determine where to route a particular work item, and connect the work item to an available employee. For the purposes of the present disclosure, “ACD” refers to any combination of hardware, software and/or embedded logic that is operable to automatically distribute incoming work items, including requests for service transmitted using any audio and/or video means, including signals, data or messages transmitted through voice devices, text chat, web sessions, facsimile, instant messaging and e-mail.

According to one or more embodiments, ACD 105 includes a processor, a network interface, and a memory module or database. The network interface joins ACD 105 with a local area network. Once ACD 105 receives a work item, the processor determines which of a plurality of agents should receive the work item. For example, the processor may access the memory module, which stores code executed by the processor to perform various tasks.

In various embodiments, the processor includes a plurality of engines or modules. Examples of suitable engines include a distributor engine, a queue engine, and a monitor engine. The distributor engine distributes incoming work items to available agents, the queue engine monitors and maintains work items that are waiting to be connected to agents, and the monitor engine checks the status and skills of agents and stores appropriate information in the memory module.

The collected data of agents handling contacts can be sent from ACD 105 to WFM system 110. WFM system 110 is a system that predicts the work anticipated in a contact center at a given point of time and calculates the number of agents required to handle the work. Additionally, WFM system 110 schedules the agents to handle the work. WFM system 110 can also identify the number of agents that are predicted versus scheduled to handle the contacts at a given point of time. This process is determining net staffing data, and it is often seen that there are situations where the number of agents scheduled is much greater (or smaller) than needed.

Reverse opportunity calculator 115 looks at the net staffing data to understand overstaffing situations and align agents with different opportunities. Supervisor 102 is the user who manages agents' work schedules and his/her performance in a contact center. Supervisor 102 can review the schedules and can modify them for better coverage in the contact center. Supervisor 102 needs insights about understaffing and overstaffing situations to proactively assign agents for a better work schedule and workforce optimization.

In day-to-day contact center operations, ACD 105 periodically sends WFM system 110 contact data and data related to how an agent handled those contacts. These consolidated historical data points on an interval level (e.g., a 15 minute interval) are used by WFM system 110 as core data for forecasted functions. Typically, historical data is fed by ACD 105 to forecasting engine 111 of WFM system 110. Forecasting engine 111 forecasts the expected contact volumes and average handle times for a given contact type. This information is used by staffing engine 112 to predict the number of agents needed to handle the forecasted call volumes in the most optimized manner. Forecasting engine 111 generates and transmits forecasted volumes to staffing engine 112, which then delivers staffing requirements to scheduling engine 113. Scheduling engine 113 uses the staffing data as an input to generate automated schedules for agents.

Workforce managers often fix schedules manually and see differences between the actual scheduled agents to handle contacts for a given period and what was prepared by staffing engine 112. This difference in data is called net staffing data.

On careful consideration of the net staffing data, managers and supervisors can identify scenarios of overstaffing or understaffing in the WFM system 110. Understaffing means that the contact center has a smaller number of agents available to handle contacts at a given time than required. Ideally, supervisors and workforce managers handle these scenarios very well. Overstaffing means that the contact center has more agents available to handle contacts at a given time than required, which means these agents are not engaged and occupied. These scenarios need more detailed analysis and knowledge of areas where these can be utilized.

In one or more embodiments, scheduling engine 113 transmits net staffing information to reverse opportunity calculator 115. Reverse opportunity calculator 115 uses the net staffing data to identify opportunities in the WFM system 110 automatically and recommend to supervisors or workforce managers how to better utilize these agents and keep them engaged and occupied in different situations without doing tedious analysis on their end via manual reports or previous know-how. Reverse opportunity calculator 115 can run in two modes: (1) automated mode, where it can run at the end of each day automatically, or (2) initiated manually by a supervisor on-demand.

Reverse opportunity calculator 115, after looking at the net staffing information and running its business logic on top of it, provides, to the supervisor and workforce managers, different opportunities available to be taken up by these available agents. These opportunities can be coaching time for agents, assigning them to outbound calling on the fly, or rescheduling whenever necessary. Reverse opportunity calculator 115 is useful as it presents information to the supervisor and workforce managers, along with calculated data and recommendations available across the WFM system 110, which may go untapped. This builds confidence in supervisors and workforce managers to take corrective action based on decisions and data provided by reverse opportunity calculator 115.

Supervisor 102, based on the opportunities, can then assign coaching 120, assign staff to the calling list in ACD 105, and/or reallocate staff to understaffed scheduling units and resubmit to scheduling engine 113. A scheduling unit (SU) organizes agents into groups with common scheduling requirements. The requirements include the unit's operating days and hours, which may have more than one working shift. For example, groups of agents working specific shifts in a specific location or employees working in a specific department may be in one SU.

ACD systems 105 typically have a list of customers for outbound calling for selling and campaign purposes. These lists are called calling lists and are an opportunity for available agents in the system to attend and complete these proactively.

WFM systems 110 have learning systems called coaching where agents are assigned coaching packages by their managers to improve their skills. Unassigned agents can better leverage their time to complete these coaching and improve their skills according to the present disclosure.

Net staffing in certain scenarios can also turn out to be negative, which means scheduled agents are less than the number of required agents. This is an opportunity to move available agents from different units to the current unit, e.g., to handle customer issues more quickly. The unit can be a SU or a management unit.

All of these opportunities are listed for workforce managers at a single place to look and take corrective actions. The present automated methods provide agent utilization opportunities and make it easier for managers to make decisions and achieve better cost savings for their contact centers.

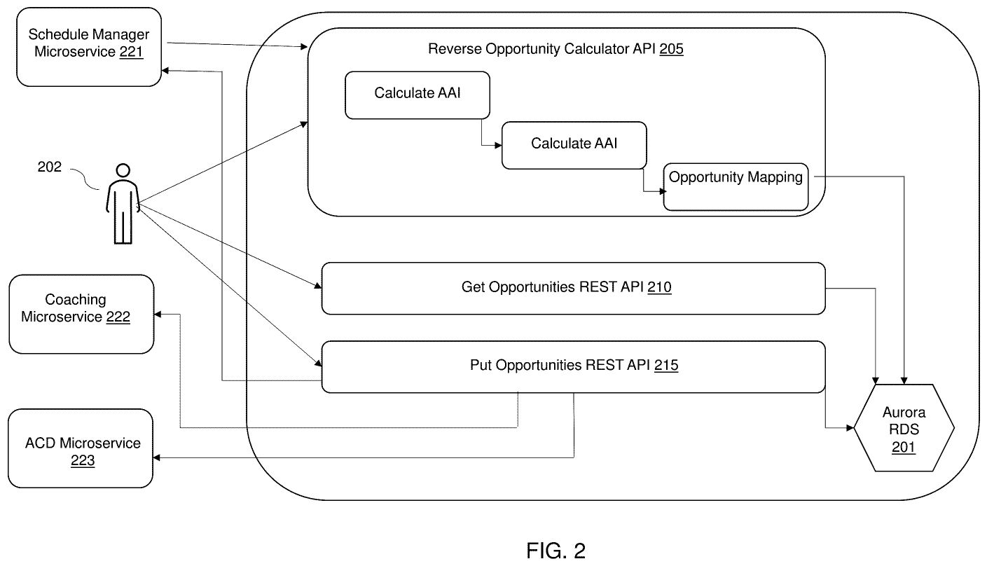

FIG. 2 illustrates an exemplary architecture of reverse opportunity calculator 115. As part of the present methods, a new microservice is deployed, which is powered, in an exemplary embodiment, by Amazon Web Services Elastic Compute Cloud (AWS EC2) infrastructure. The microservice is backed up by the Aurora Relational Database Service (RDS) database 201, which stores the information about the opportunities calculated. Overall, the microservice provides three (3) application program interfaces (APIs).

Reverse opportunity calculator API 205 is responsible for calculating opportunities that are available in the system. This step can be initiated by scheduling engine 113 right after the schedules are generated or it can be manually triggered by a WFM supervisor/manager to recalculate opportunities based on a current scenario in the system, which may have changed after these were generated last based on automated flow. It works as a three (3) step process. Calculate available agents per interval (AAI), calculate total addressable contacts (TAC), and perform opportunity mapping. Once the opportunities are calculated, they are stored in an structured query language (SQL) database, such as Aurora RDS 201 to be utilized later.

The get opportunities representational state transfer (REST) API 210 is used to fetch the list of opportunities stored in the database 201. These opportunities are then returned to the user 202 to be displayed on a user interface.

The put opportunities REST API 215 is used to execute the accept action on the opportunities presented to the user 202. Under the hood, it updates the status of the opportunity in the SQL database, and calls the respective module based on the opportunity accepted (e.g., schedule manager microservice 221, coaching microservice 222, or ACD microservice 223).

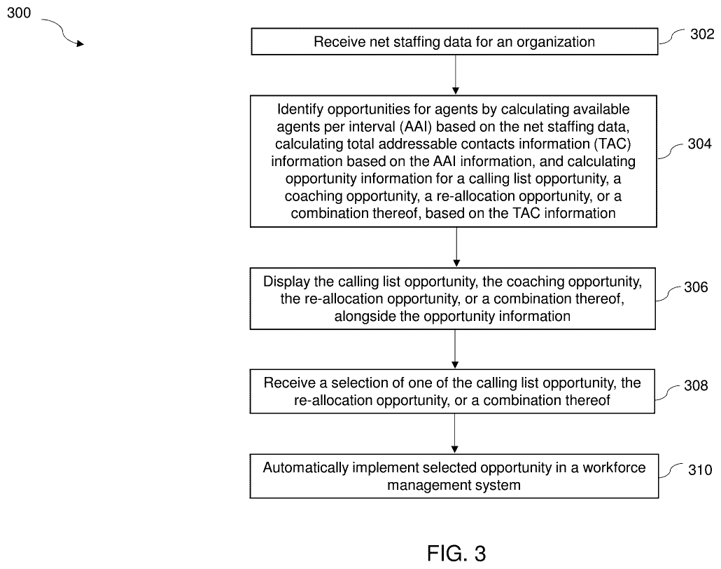

Referring now to FIG. 3, a method 300 according to embodiments of the present disclosure is described. At step 302, reverse opportunity calculator 115 receives net staffing data for an organization. In various embodiments, net staffing data includes one or more of percentage of SUs overstaffed, percentage of SUs understaffed, or percentage of AAI per SU.

At step 304, reverse opportunity calculator 115 identifies opportunities for agents by calculating available agents per interval (AAI) information based on the net staffing data, calculating total addressable contacts (TAC) information based on the AAI information, and calculating opportunity information for a calling list opportunity, a coaching opportunity, a re-allocation opportunity, or a combination thereof, based on the TAC information.

In one or more embodiments, calculating the AAI information includes calculating one or more of average agents per SU, AAI per SU, or AAI for a tenant. In some embodiments, calculating the TAC information includes calculating one or more of TAC per hour, TAC per SU, TAC per SU for an overstaffed SU, TAC per SU for an understaffed SU, TAC per day, or TAC with addressable skills per day. In several embodiments, calculating the opportunity information includes calculating a percentage of an overstaffing situation addressed and a percentage of an opportunity that can be addressed.

At step 306, reverse opportunity calculator 115 displays the calling list opportunity, the coaching opportunity, the re-allocation opportunity, or a combination thereof, alongside the opportunity information.

At step 308, reverse opportunity calculator 115 receives a selection of one of the calling list opportunity, the coaching opportunity, the re-allocation opportunity, or a combination thereof.

At step 310, reverse opportunity calculator 115, in response to the selection, automatically implements the selected calling list opportunity, the selected coaching opportunity, the selected re-allocation opportunity, or a combination thereof, in WFM system 110. In one or more embodiments, the re-allocation opportunity is selected and automatically implementing the selected opportunity in WFM system 110 includes generating a schedule for re-allocated agents.

In some embodiments, method 300 further includes storing the calling list opportunity, the coaching opportunity, the re-allocation opportunity, or a combination thereof.

In various embodiments, method 300 further includes receiving a request to re-calculate the opportunity information, re-calculating the opportunity information, and displaying the re-calculated opportunity information.

To better understand the method 300, the following example is provided. The calculations below are divided into facts, base calculations derived from the facts, and opportunity calculations that are the results. The calculations are described below.

In one or more embodiments, the following facts are obtained:
1. Total Agents (total number of agents in the tenant)
2. Number of SUs (total number of scheduling units in the tenant)
3. Calls that agent can handle in an hour (AHT=6 min)
4. Calling list volume (total number of target calls in the calling list)
5. Coaching plan eligible hours (1 hr per agent)
6. % of skills covered in calling list
7. % of SUs overstaffed
8. % of SUs understaffed
9. % of AAI per SU (assumed percentage of agents available per interval in every SU)
10. Number of SUs overstaffed
11. Number of SUs understaffed

The below exemplary values for the facts were simulated.

TABLE 1
SIMULATED VALUES FOR FACTS

| Name | Value |
|---|---|
| Total Agents | 800 |
| Number of Scheduling Units (SUs) | 46 |
| Calls that agent can handle in an hour (AHT = 6 min) | 7 |
| Calling list volume | 1500 |
| Coaching plan eligible hours (1 hr per agent) | 20 |
| % of skills covered in calling list | 20 |
| % of SUs overstaffed | 10 |
| % of SUs understaffed | 5 |
| % of AAI per SU | 15 |
| Number of SUs overstaffed | 5.00 |
| Number of SUs understaffed | 3.00 |

In one or more embodiments, the following base calculations, derived from the facts, are determined.

### AAI Calculations

1. Average agents per SU
2. AAI per SU
3. AAI for entire tenant

### TAC Calculations

4. TAC per hour
5. TAC per SU
6. TAC per SU for overstaffed SU
7. TAC per SU for understaffed SU
8. TAC per day
9. TAC with addressable skills per day

The below base calculations are simulated, based on the simulated facts in Table 1.

TABLE 2
SIMULATED AAI CALCULATIONS

| Name | Formula | Value |
|---|---|---|
| Average agents per SU | Total agents/Number of SUs | 17.39 |
| AAI per SU | Average agents per SU * % of AAI per | 2.61 |
| | SU | |
| AAI for entire tenant | (AAI per SU * Number of SUs | 5.22 |
| | overstaffed) − AAI per SU * | |
| | Number of SUs understaffed | |

TABLE 3
SIMULATED TAC CALCULATIONS

| Name | Formula | Value |
|---|---|---|
| TAC per hour | AAI per tenant * Calls per agent per | 36.52 |
| | hour | |
| TAC per SU | AAI per SU * number of calls that | 18.26 |
| | agent can handle | |
| TAC Per SU for | TAC per SU * number of overstaffed | 91.30 |
| overstaffed SU | Sus | |
| TAC Per SU for | TAC per SU * number of understaffed | 54.78 |
| understaffed SU | Sus | |
| TAC per day | (TAC per SU for overstaffed SU − TAC | 292.17 |
| | per SU for understaffed SU) * 8 | |
| TAC with addressable | (TAC per day * % of skills covered in | 58.43 |
| skills per day | calling list)/100 | |

There are three (3) possible opportunities: calling list, coaching, and reallocation or rescheduling. All three possibilities are considered when calculating scores. To understand the effectiveness of each opportunity, there are two (2) metrics that are calculated as shown below.

The overstaffing situation addressed represents the percentage of overstaffing situation that can be addressed when the opportunity is accepted. For example, if there is an overstaffing situation of ten (10) agents and the opportunity can utilize six (6) of them, then the metric would be calculated as 60%.

The opportunity score represents the percentage of opportunity that can be addressed by redirecting the overstaffed agent towards this opportunity. For example, if there is a calling list that needs ten (10) agents and there is an overstaffing situation of eight (8) agents, then the metric would be calculated as 80%.

Both of these metrics are calculated below, based on the simulated data from Tables 2 and 3.

TABLE 4
SIMULATED OVERSTAFFING SITUATION ADDRESSED

| Opportunity | Overstaffing Situation (%) Addressed Formula | Value |
|---|---|---|
| Calling list | TAC with addressable skills per day/TAC per day | 20.00 |
| | (maximum 100%) | |
| Coaching | Coaching plan eligible hours (1 hr per | 6.85 |
| | agent)/TAC per day (maximum of 100%) | |
| Rescheduling | TAC per SU for understaffed SU/TAC per SU for | 60.00 |
| | overstaffed SU (maximum 100%) | |

TABLE 5
SIMULATED OPPORTUNITY SCORE

| Opportunity | Opportunity Score (%) Formula | Value |
|---|---|---|
| Calling list | TAC with addressable skills per day/Calling | 3.90 |
| | list volume | |
| Coaching | TAC per day/Coaching plan eligible hours | 100.00 |
| | (1 hour per agent) (maximum 100%) | |
| Rescheduling | TAC per SU for overstaffed SU/TAC per | 100.00 |
| | SU for understaffed SU (maximum 100%) | |

The full data structures are provided below.

```
i. Net Staffing:
      {
        “totalNet” : [ {
          “periodStartTime” : “2023-07-13T00:00:00Z”,
          “required” : null,
          “staffed” : 0.0,
          “net” : 0.0
        }, {
          “periodStartTime” : “2023-07-13T00:15:00Z”,
          “required” : null,
          “staffed” : 0.0,
          “net” : 0.0
        }
      ],
        “firstPeriodStart” : “2023-07-13T00:00:00Z”,
        “periodLength” : “PT15M“
      }
ii. Forecasted Data:
      {
              SkillName: “Email”
              UtcTimeZone: “UTC-00:00”
              IntervalDuration: “15”
              UtcStartDateTime: “2023-07-13T00:00:00Z”
              OfferedCalls: 10
              AnsweredCalls: 5
              AbandonedCalls: 5
              AverageHandleTime: 300
              AverageAbandonmentTime: 200
              Dials: 10
              Connects: 6
              ConnectsAht: 250
              RightPartyConnects: 2
              RightPartyConnectsAht: 600
      }
iii. Historical Data:
  {
      “Queue Value”: “112555”.
      “QueueName”: “Email”,
      “IsOutbound”: false,
      “ContactsReceived”: 5,
        “AbandonedShort”: 1,
              “AbandonedLong”: 1,
              “HandledShort”: 3,
              “HandledLong”: 1,
              “Active”: 19,
              “HandleTime”: 725,
              “WorkTime”: 89,
              “QueueDelayTime”: 51,
              “SvcLvlPct”: 93.0,
              “RightPartyHandleTime”: 0,
              “RightPartyContacts”: 0,
              “WrongPartyHandleTime”: 0,
              “WrongPartyContacts”: 0,
              “Backlog”: 5,
              “BacklogNotExpired”: 0,
              “BacklogExpired”: 5,
              “HoldTime”: 0
      }
iv. Calling List:
  [
  {
    “External ID”: 27316423,
    “Score”: “”,
    “Telephone”: 17027017022,
    “Customer Field 1”: “”,
    “Customer Field 2”: “”,
    “Caller ID”: “”,
    “Priority”: “”,
    “Compliance Required”: “”,
    “First Name”: “TOD V”,
    “Last Name”: “CEPEDB”,
    “Address”: “”,
    'City”: “”,
    “State”: “”,
    'Zip”: “”,
    “Time_Zone”: “”,
    “Preview Required”: “”,
    “Agent”: “”,
    “Override Finalization”: “”,
    “Call Request Date”: {
      “Time”: “”
    },
    “Call Request Stale Minutes”: “”,
    “Notes”: “”,
    “Expiration Date”: “”,
    “Start Time”: “”,
    “End Time”: “”,
    “IC_CreatedDate”: “14-07-2023 08:28:47”,
    “IC_ModifiedDate”: “14-07-2023 11:16:03”,
    “IC_Attempts”: 1,
    “IC_FinalizationStatus”: “ContactExhausted”,
    “IC_AssignedSkill_No”: 10623822,
    “IC_ConfirmationRequired”: false,
    “IC_ComplianceRecord”: null,
    “IC_Priority”: false,
    “IC_SourceActive”: true,
    “IC_SourceRemoved”: false,
    “IC_TimeZoneNames”: “Pacific”,
    “IC_TargetAgent”: “”,
    “IC_TargetAgentName”: “”,
    “IC_ProspectiveContactDestination Value”: 999999022,
    “IC_ProspectiveContactDestinationDesc”: “PhoneNumber”,
    “IC_ProspectiveContactDestinationType”: “Phone”,
    “IC_DateOfLastCall”: “14-07-2023 16:16:03”,
    “IC_LastCallDuration”: “1/1/1900 0:01”,
    “IC_LastCallDurationSeconds”: 78.5,
    “IC_SystemClassification”: 82,
    “IC_SystemClassificationName”: “Answering Machine - Proactive
  Identified”,
    “IC_AgentDisposition”: −82,
    “IC_AgentDispositionDescription”: “”,
    “IC_Agent_No”: 34518564,
    “IC_AgentName”: “Mario Bros”,
    “IC_CallNotes”: “”,
    “IC_CommitmentAmount”: “”,
    “IC_CallerIdUsed”: 8882754524,
    “IC_DeliveredComplianceRecord”: false,
    “IC_DeliveredConfirmationRequired”: true,
    “IC_ContactDeliveryType”: “None”,
    “IC_DeliveredPriority”: false,
    “IC_DeliveredAsCallback”: false,
    “IC_DeliveredAgentSpecific”: false,
    “IC_CallbackDateTimeGMT”: “”,
    “IC_CallbackAgent”: “”,
    “IC_CallbackNumber”: 99999017022,
    “IC_CallbackAgentName”: “”,
    “IC_CallbackNotes”: “”,
    “IC_CallRequestDateTime”: “”,
    “IC_CallRequestStaleMinutes“. “”,
    “IC_ProspectiveContactExpirationDate”: “15-07-2023 13:28:47”
  }
v. Coaching:
        {
          “plans” : [ {
            “coachingPlanId” : “54d752cb-6182-473b-b198-71c94b471e33”,
            “planName” : “ZZZ”,
            “startTime” : “2022-06-03T15:29:20.738Z”,
            “endTime” : “2022-06-04T03:59:59.999Z”,
            “coachingPackageUUID” : “11ece351-dbe9-03a0-92e2-
        0242ac110003”,
            “coachingPackage Version” : 0,
            “status” : “CLOSED”,
            “createdBy” : “11ec1257-35ac-8011-812f-005056a16dd7”,
            “lastModifiedBy” : “COACHING_SCHEDULER”,
            “assignees” : [ “11ecd78b-4d15-e7f0-899f-0242ac110003” ],
            “assigneeCount” : 1,
            “lastModifiedTime” : “2022-06-04T06:00:12.784Z”,
            “createdTime” : “2022-06-03T15:31:25.605Z”,
            “tenantId” : “11e9fad2-1a94-6a03-80f8-005056a16dd7”,
            “responses” : 0,
            “assignments” : [ ]
          }]
        }
vi. AAI:
        {
            SU: “123”,
            Skill: ‘XYZ’,
            periodStartTime : “2023-07-13T00:00:00Z”,
            AAI: “3.4”
        }
vii. TAC:
        {
            SU: “123”,
            Skill: ‘XYZ’,
            periodStartTime : “2023-07-13T00:00:00Z”,
            AAI: “1.4”
        }
viii. Opportunity:
        {
            SU: “123”,
            Skill: ‘XYZ’,
            periodStartTime : “2023-07-13T00:00:00Z”,
            type: “CallingList”,
            score: 76,
            overstaffingAddressed: 98
        }
```

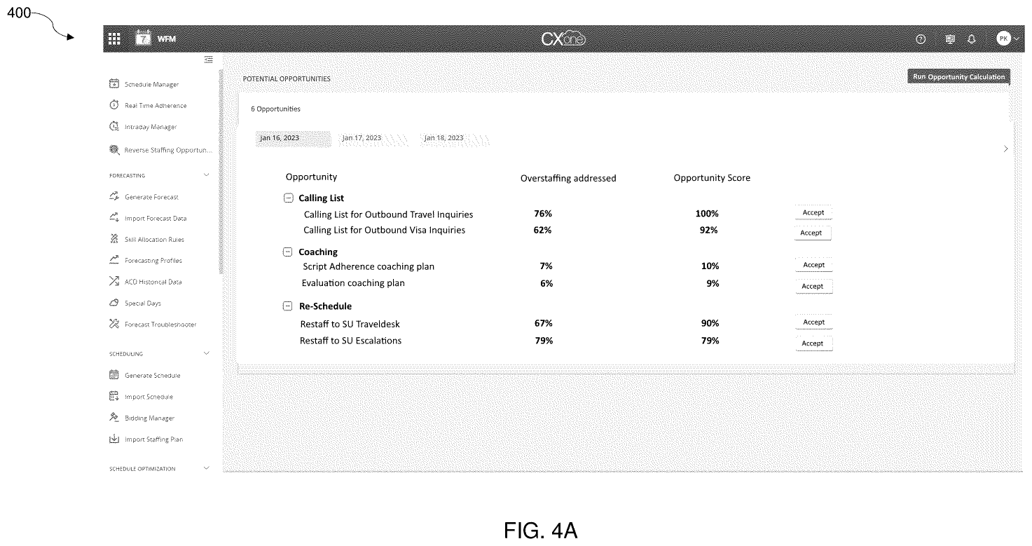

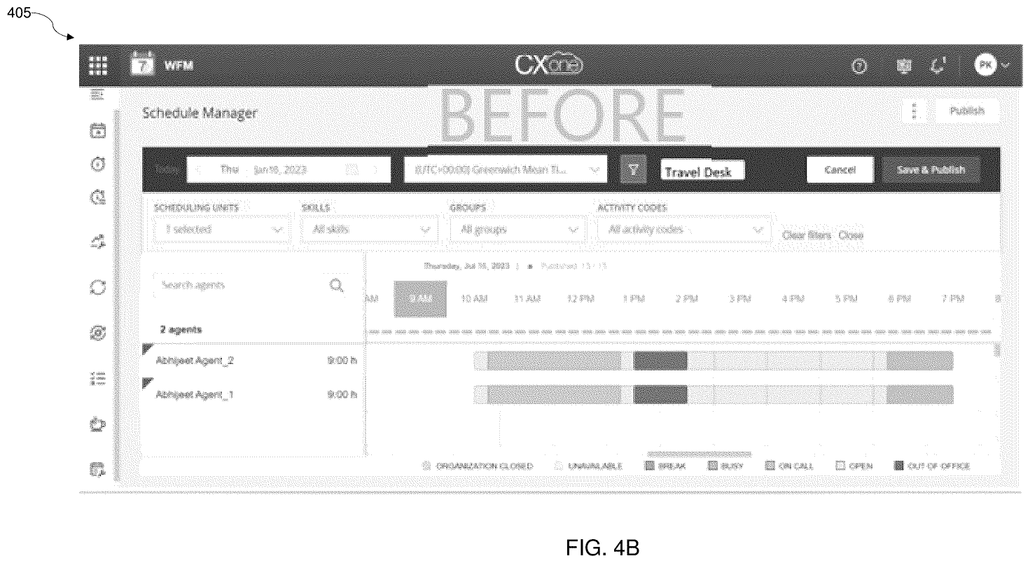

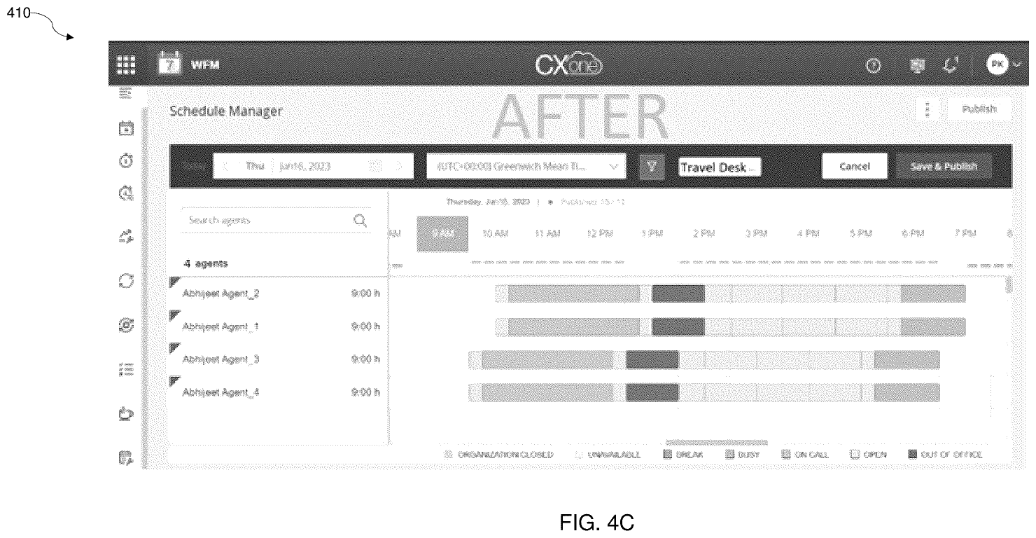

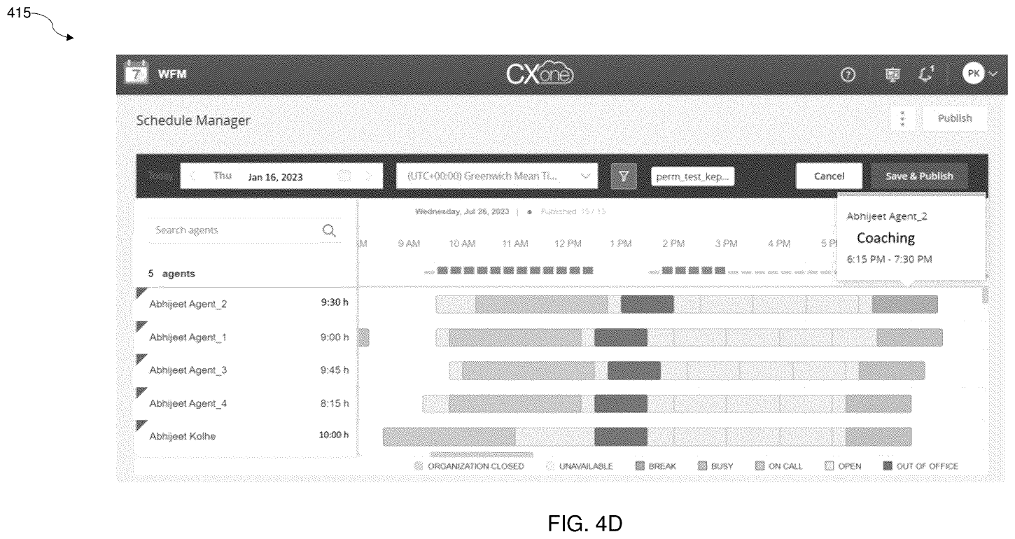

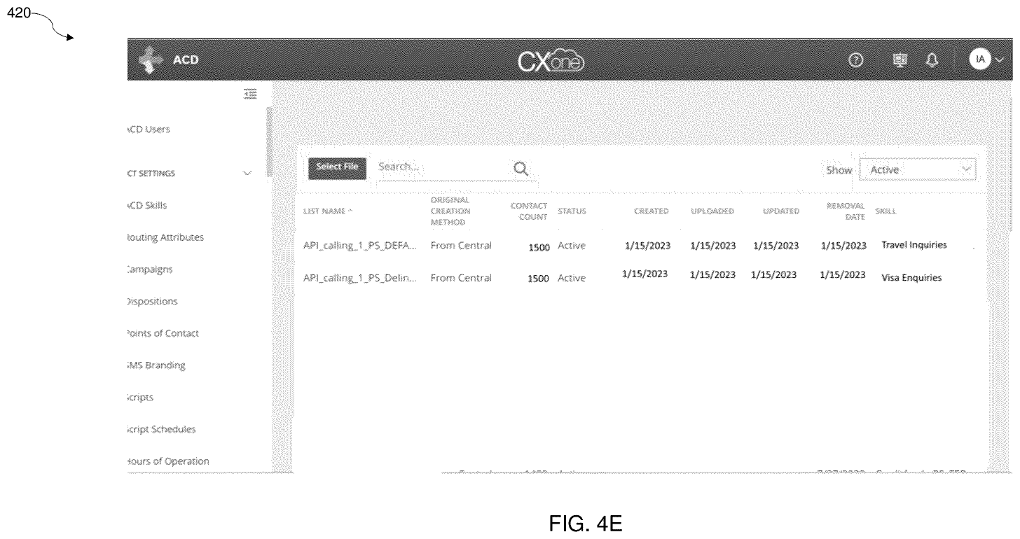

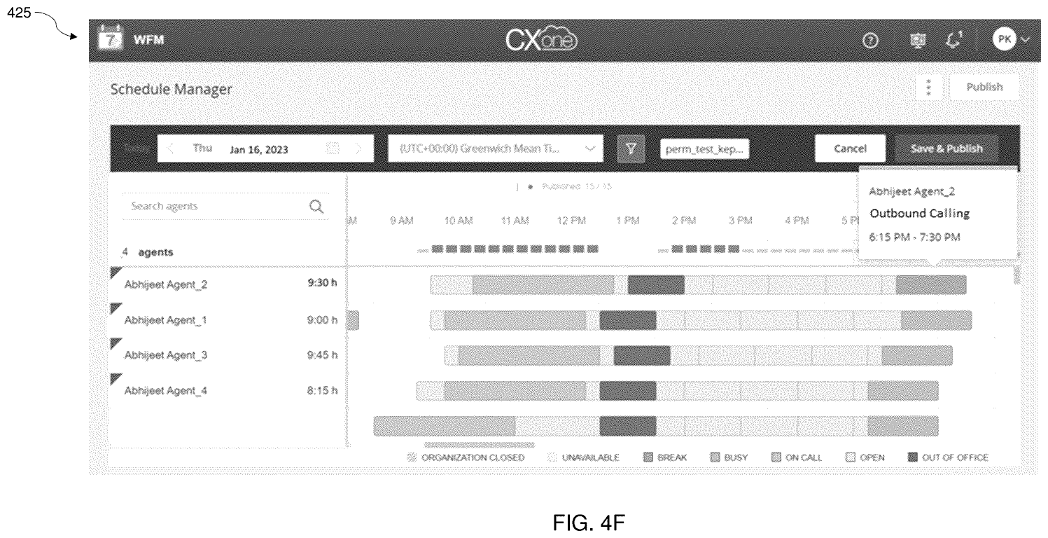

FIG. 4A illustrates an exemplary user interface 400 that may be displayed to a supervisor to view possible opportunities. As can be seen, calling list opportunities, coaching opportunities, and re-scheduling opportunities are available. Alongside each opportunity, the overstaffing (or understaffing) situation addressed and the opportunity score are displayed, as well as an accept button for the supervisor to accept the opportunity. Also shown at the top right corner is a run opportunity calculation button, which provides an opportunity to the supervisor to re-run the opportunity calculation in case the staffing has changed after the automated flow has run, and the supervisor expects to have more recent data. User interface 400 shows an opportunity to reschedule with an opportunity score of 90% for the SU travel desk.

FIG. 4B illustrates user interface 405 that shows how the SU travel desk looks like for Jan. 16, 2023. As can be seen, SU travel desk is understaffed with only two agents. Upon accepting the opportunity, the supervisor sees the rescheduled agents in SU travel desk in user interface 410 of FIG. 4C. The SU travel desk is not understaffed anymore since it is now staffed with four agents.

Referring back to FIG. 4A, the supervisor sees an opportunity to use the overstaffed SUs and assign agents with some on-the-fly coaching. There is an opportunity score of 10% for the script adherence coaching plan. When the supervisor accepts this opportunity by clicking on the accept button, WFM system 110 automatically detects the relevant coaching plans for agents, assigns them, and reflects these coaching activities on their schedules as shown in user interface 415 of FIG. 4D.

Still referring to FIG. 4A, the supervisor sees an opportunity to use the overstaffed SUs and assign agents to take outbound calls in a calling list. Calling list identification is done based on the skill and WFM system 110 automatically suggests which calling list and agent will do these outbound calls. FIG. 4E illustrates user interface 420 showing the calling lists. FIG. 4F illustrates user interface 425 after the supervisor accepts a calling list opportunity.

In one or more embodiments, upon selection of an opportunity, reverse opportunity calculator 115 maintains a count of the remaining opportunities and displays the remaining opportunities to the supervisor so that the supervisor can decide the best action.

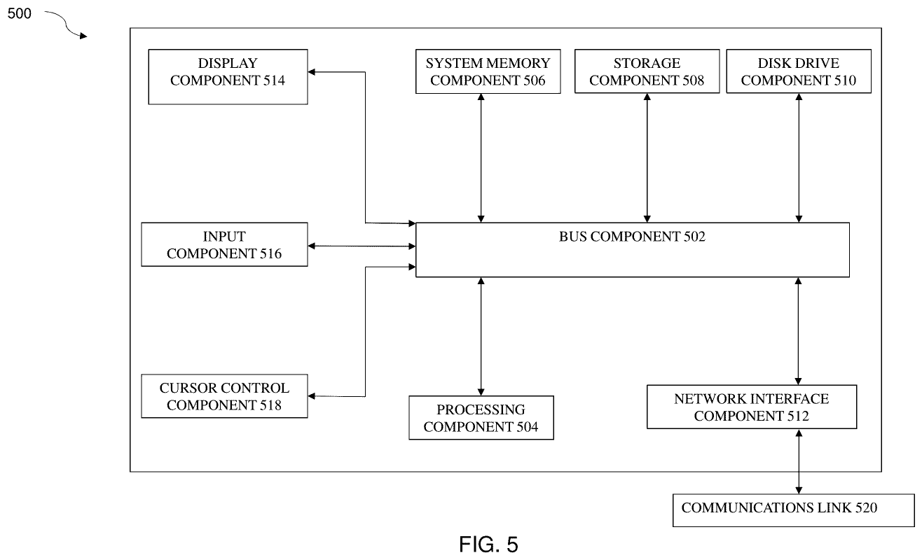

Referring now to FIG. 5, illustrated is a block diagram of a system 500 suitable for implementing embodiments of the present disclosure. System 500, such as part of a computer and/or a network server, includes a bus 502 or other communication mechanism for communicating information, which interconnects subsystems and components, including one or more of a processing component 504 (e.g., processor, micro-controller, digital signal processor (DSP), etc.), a system memory component 506 (e.g., RAM), a static storage component 508 (e.g., ROM), a network interface component 512, a display component 514 (or alternatively, an interface to an external display), an input component 516 (e.g., keypad or keyboard), and a cursor control component 518 (e.g., a mouse pad).

In accordance with embodiments of the present disclosure, system 500 performs specific operations by processor 504 executing one or more sequences of one or more instructions contained in system memory component 506. Such instructions may be read into system memory component 506 from another computer readable medium, such as static storage component 508. These may include instructions to receive net staffing data for an organization; identify opportunities for agents by: calculating available agents per interval (AAI) information based on the net staffing data, calculating total addressable contacts (TAC) information based on the AAI information, and calculating opportunity information for a calling list opportunity, a coaching opportunity, a re-allocation opportunity, or a combination thereof, based on the TAC information; display the calling list opportunity, the coaching opportunity, the re-allocation opportunity, or a combination thereof, alongside the opportunity information; receive a selection of one of the calling list opportunity, the coaching opportunity, the re-allocation opportunity, or a combination thereof; and in response to the selection, automatically implement the selected calling list opportunity, the selected coaching opportunity, the selected re-allocation opportunity, or a combination thereof, in a workforce management system. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, volatile media includes dynamic memory, such as system memory component 506, and transmission media includes coaxial cables, copper wire, and fiber optics, including wires that comprise bus 502. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 500. In various other embodiments, a plurality of systems 500 coupled by communication link 520 (e.g., LAN, WLAN, PTSN, or various other wired or wireless networks) may perform instruction sequences to practice the disclosure in coordination with one another. Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

The Abstract at the end of this disclosure is provided to comply with 37 C.F.R. § 1.72 (b) to allow a quick determination of the nature of the technical disclosure. It is submitted with the understanding that it will not be used to interpret or limit the scope or meaning of the claims.

What is claimed is:

1. An agent utilization system comprising:
a processor and a computer readable medium operably coupled thereto, the computer readable medium comprising a plurality of instructions stored in association therewith that are accessible to, and executable by, the processor, to perform operations which comprise:
receiving net staffing data for an organization;
identifying opportunities for agents by:
calculating available agents per interval (AAI) information based on the net staffing data,
calculating total addressable contacts (TAC) information based on the AAI information, and
calculating opportunity information for a calling list opportunity, a coaching opportunity, a re-allocation opportunity, or a combination thereof, based on the TAC information;
displaying the calling list opportunity, the coaching opportunity, the re-allocation opportunity, or a combination thereof, alongside the opportunity information;
receiving a selection of one of the calling list opportunity, the coaching opportunity, the re-allocation opportunity, or a combination thereof; and
in response to the selection, automatically implementing the selected calling list opportunity, the selected coaching opportunity, the selected re-allocation opportunity, or a combination thereof, in a workforce management system.

2. The agent utilization system of claim 1, wherein the operations further comprise storing the calling list opportunity, the coaching opportunity, the re-allocation opportunity, or a combination thereof.

3. The agent utilization system of claim 1, wherein the net staffing data comprises one or more of percentage of scheduling units overstaffed, percentage of scheduling units understaffed, or percentage of AAI per scheduling unit.

4. The agent utilization system of claim 1, wherein calculating the AAI information comprises calculating one or more of average agents per scheduling unit, AAI per scheduling unit, or AAI for a tenant.

5. The agent utilization system of claim 1, wherein calculating the TAC information comprises calculating one or more of TAC per hour, TAC per scheduling unit, TAC per scheduling unit for an overstaffed scheduling unit, TAC per scheduling unit for an understaffed scheduling unit, TAC per day, or TAC with addressable skills per day.

6. The agent utilization system of claim 1, wherein calculating the opportunity information comprises calculating a percentage of an overstaffing situation addressed and a percentage of an opportunity that can be addressed.

7. The agent utilization system of claim 1, wherein the operations further comprise:
receiving a request to re-calculate the opportunity information;
re-calculating the opportunity information; and
displaying the re-calculated opportunity information.

8. The agent utilization system of claim 1, wherein the re-allocation opportunity is selected and automatically implementing the selected opportunity in a workforce management system comprises generating a schedule for re-allocated agents.

9. A method of identifying and implementing opportunities for agents, which comprises:
receiving net staffing data for an organization;
identifying opportunities for agents by:
calculating available agents per interval (AAI) information based on the net staffing data,
calculating total addressable contacts (TAC) information based on the AAI information, and
calculating opportunity information for a calling list opportunity, a coaching opportunity, a re-allocation opportunity, or a combination thereof, based on the TAC information;
displaying the calling list opportunity, the coaching opportunity, the re-allocation opportunity, or a combination thereof, alongside the opportunity information;
receiving a selection of one of the calling list opportunity, the coaching opportunity, the re-allocation opportunity, or a combination thereof; and
in response to the selection, automatically implementing the selected calling list opportunity, the selected coaching opportunity, the selected re-allocation opportunity, or a combination thereof, in a workforce management system.

10. The method of claim 9, wherein the net staffing data comprises one or more of percentage of scheduling units overstaffed, percentage of scheduling units understaffed, or percentage of AAI per scheduling unit.

11. The method of claim 9, wherein calculating the AAI information comprises calculating one or more of average agents per scheduling unit, AAI per scheduling unit, or AAI for a tenant.

12. The method of claim 9, wherein calculating the TAC information comprises calculating one or more of TAC per hour, TAC per scheduling unit, TAC per scheduling unit for an overstaffed scheduling unit, TAC per scheduling unit for an understaffed scheduling unit, TAC per day, or TAC with addressable skills per day.

13. The method of claim 9, wherein calculating the opportunity information comprises calculating a percentage of an overstaffing situation addressed and a percentage of an opportunity that can be addressed.

14. The method of claim 9, which further comprises:
receiving a request to re-calculate the opportunity information;
re-calculating the opportunity information; and
displaying the re-calculated opportunity information.

15. A non-transitory computer-readable medium having stored thereon computer-readable instructions executable by a processor to perform operations which comprise:
receiving net staffing data for an organization;
identifying opportunities for agents by:
calculating available agents per interval (AAI) information based on the net staffing data,
calculating total addressable contacts (TAC) information based on the AAI information, and
calculating opportunity information for a calling list opportunity, a coaching opportunity, a re-allocation opportunity, or a combination thereof, based on the TAC information;
displaying the calling list opportunity, the coaching opportunity, the re-allocation opportunity, or a combination thereof alongside the opportunity information;
receiving a selection of one of the calling list opportunity, the coaching opportunity, the re-allocation opportunity, or a combination thereof; and
in response to the selection, automatically implementing the selected calling list opportunity, the selected coaching opportunity, the selected re-allocation opportunity, or a combination thereof, in a workforce management system.

16. The non-transitory computer-readable medium of claim 15, wherein the net staffing data comprises one or more of percentage of scheduling units overstaffed, percentage of scheduling units understaffed, or percentage of AAI per scheduling unit.

17. The non-transitory computer-readable medium of claim 15, wherein calculating the AAI information comprises calculating one or more of average agents per scheduling unit, AAI per scheduling unit, or AAI for a tenant.

18. The non-transitory computer-readable medium of claim 15, wherein calculating the TAC information comprises calculating one or more of TAC per hour, TAC per scheduling unit, TAC per scheduling unit for an overstaffed scheduling unit, TAC per scheduling unit for an understaffed scheduling unit, TAC per day, or TAC with addressable skills per day.

19. The non-transitory computer-readable medium of claim 15, wherein calculating the opportunity information comprises calculating a percentage of an overstaffing situation addressed and a percentage of an opportunity that can be addressed.

20. The non-transitory computer-readable medium of claim 15, wherein the operations further comprise:
receiving a request to re-calculate the opportunity information;
re-calculating the opportunity information; and
displaying the re-calculated opportunity information.
